(19) United States
(12) Patent Application Publication
(10) Pub. No.: US 2019/0317749 A1
(43) Pub. Date: Oct. 17, 2019

(54) UPGRADING NETWORK FIRMWARE

(71) Applicant: Cisco Technology, Inc., San Jose, CA (US)

(72) Inventors: Die Hu, Shanghai (CN); Kang Li, Suzhou (CN); Huimin She, Shanghai (CN); Xiang Fang, Shanghai (CN)

(21) Appl. No.: 15/952,566

(22) Filed: Apr. 13, 2018

(51) Int. Cl. G06F 8/65; H04L 12/24

(52) U.S. Cl. CPC G06F 8/65; H04L 41/082

(57) ABSTRACT

In a multiple interface, low power and lossy network comprising multiple nodes, a Network Management System (“NMS”) communicating firmware upgrades in each node of a network utilizing centralized scheduling and distributed dissemination of firmware blocks. A firmware update image is broken into blocks and transmitted throughout the network of nodes. In certain instances, every node does not receive every firmware block. The NMS receives a bitmap from the nodes indicating which of the blocks each node is missing from the update. The NMS identify particular nodes that are missing blocks and source nodes that have the blocks and are nearest to the particular recipient nodes. The NMS determines the route for the source node with the block to deliver the block to the recipient node that this missing a block. The source nodes that are identified and instructed to communicate a block to a recipient node.

### TECHNICAL FIELD

The present disclosure relates generally to computer networks and, more particularly, to communicating firmware upgrades in each node of a network utilizing centralized scheduling and distributed dissemination of firmware blocks.

### BACKGROUND

Constrained networks include, for example, Low power and Lossy Networks (LLNs), such as sensor networks. These constrained networks have a myriad of applications, such as Smart Grid, Smart Cities, home and building automation, etc. Various challenges are presented with LLNs, such as lossy links, low bandwidth, battery operation, low memory and/or processing capability, etc. Large-scale internet protocol (IP) smart object networks pose a number of technical challenges. For instance, the degree of density of such networks (such as Smart Grid networks with a large number of sensors and actuators, smart cities, or advanced metering infrastructure (AMI) networks) may be extremely high. For example, it is not rare for each node to see several hundreds of neighbors. This architecture makes routing of upgrade blocks from a central network management system to each recipient node difficult because of the often lengthy and complex pathways required.

### BRIEF DESCRIPTION OF THE DRAWINGS

FIG. 1 is a diagram depicting an example communication network, in accordance with certain examples.

FIG. 2 is a block diagram depicting an example network device/node, in accordance with certain examples.

FIG. 3 is a block diagram depicting a packet header and payload organization, in accordance with certain examples.

FIG. 4 is a diagram depicting a directed acyclic graph defined within a computer network, in accordance with certain examples.

FIG. 5 is a block diagram depicting an example communication network, in accordance with certain alternative examples.

FIG. 6 is a block flow diagram depicting a method to upgrade firmware for nodes in a network, in accordance with certain examples.

FIG. 7 is a block flow diagram depicting a method to perform an initial communication of the firmware blocks, in accordance with certain examples.

FIG. 8 is a block flow diagram depicting a method to determine a centralized strategy to communicate the missing blocks, in accordance with certain examples.

### DESCRIPTION OF EXAMPLE EMBODIMENTS

### Overview

In a multiple interface, low power and lossy network comprising a plurality of devices, the nodes are managed by a Network Management System (“NMS”). In certain systems, the NMS is responsible for upgrading firmware of each of the nodes. The firmware image is broken into blocks and transmitted throughout the network of nodes. In certain instances, every node does not receive every firmware block. The NMS must determine a method of providing an additional communication of blocks to the nodes that are missing blocks. In certain conventional networks, the NMS communicates all of blocks throughout the network multiple times. The desired result is that after multiple communications of the blocks, all of the nodes will eventually receive all of the blocks.

In certain examples, the NMS will instead develop a centralized scheduling and distributed dissemination of firmware blocks that will save processing capacity, reduce the bandwidth required for the communications, and provide all of the blocks to all of the nodes in less time. After the initial communication of the blocks to the nodes, the NMS receives a bitmap from the nodes indicating which of the blocks each node is missing from the update. The NMS analyzes a known topology map of the network to identify particular nodes that are missing blocks and source nodes possessing the blocks that are nearest to the particular recipient nodes.

The NMS determines the route for the source node with the block to deliver the block to the recipient node that this missing a block. The NMS communicates commands to the network that includes the instructions to deliver the missing blocks. Source nodes that are identified and instructed to communicate a block to a recipient node or a group of nodes, proceed to communicate the blocks by instructed method unicast or broadcast. The recipient nodes missing blocks receive the communicated blocks.

In certain example, the source node has knowledge of the topology of the network such that the source node knows the path to the recipient node. In this example, the NMS only provides instructions to the source node to deliver the block to the recipient node. In an alternate example, the source node does not have knowledge of the topology of the network, and the source node does not know the path to the recipient node. In this example, the NMS provides instructions to the source node to deliver the block to the recipient node and data specifying the path between the nodes.

By using and relying on the methods and systems described herein, a network system may use centralized scheduling and distributed dissemination of firmware blocks to achieve a more efficient, faster, and more economical distribution of firmware updates. As such, the systems and methods described herein may allow routing of upgrade blocks from a central network management system to each recipient node difficult to avoid the often lengthy and complex pathways required in conventional systems. These systems and methods will reduce the total number of communications of the firmware blocks from the NMS throughout the system. With convoluted pathways being avoided, the time and bandwidth for communication of blocks is reduced. Further, the missing blocks from the initial communication are filled with fewer communication attempts because the blocks are communicated along shorter paths and fewer interruptions occur.

### Description

Referring to the drawings, in which like numerals represent like (but not necessarily identical) elements throughout the figures, example embodiments are described.

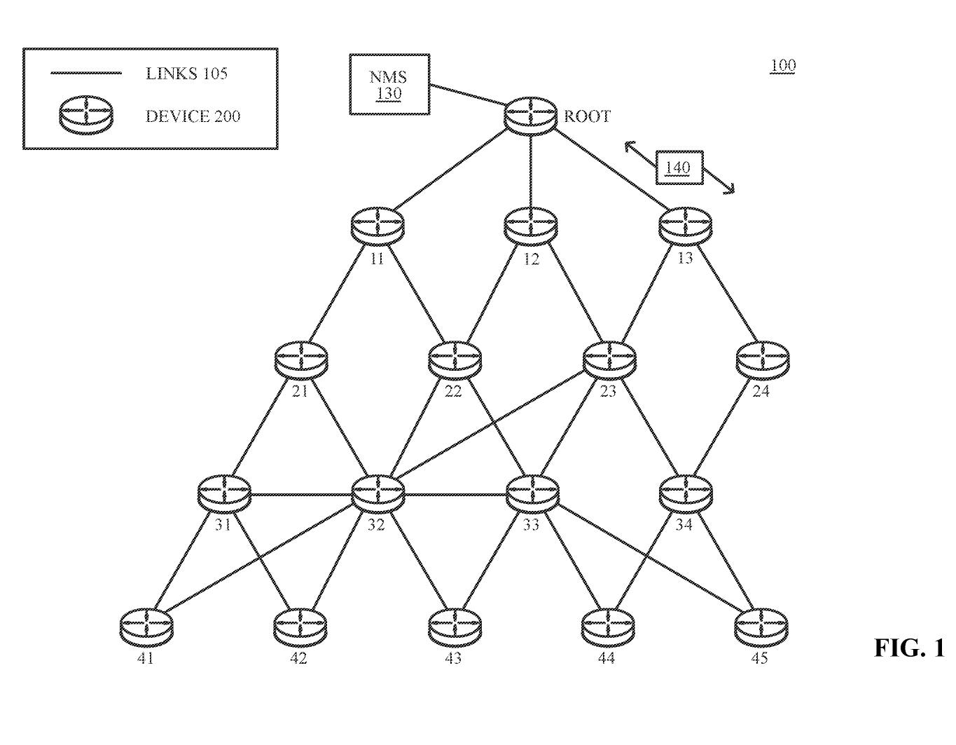

The operations described with respect to any of the FIGS. 1-8 can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

A computer network is a geographically distributed collection of nodes interconnected by communication links and segments for transporting data between end nodes. Nodes and end nodes include, for example, personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC) such as IEEE 61334, IEEE P1901.2, and others. In addition, a Mobile Ad-Hoc Network (MANET) is a kind of wireless ad-hoc network that is generally considered a self-configuring network of mobile routes (and associated hosts) connected by wireless links, the union of which forms an arbitrary topology.

Smart object networks, such as sensor networks, are a specific type of network having spatially distributed autonomous devices, such as sensors, actuators, etc., that cooperatively monitor physical or environmental conditions at different locations, such as, for example, energy/power consumption, resource consumption (for example, water/gas/etc. for advanced metering infrastructure or “AMI” applications), temperature, pressure, vibration, sound, radiation, motion, pollutants, etc. Other types of smart objects include actuators, for example, responsible for turning on/off an engine or performing any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port (such as PLC), a microcontroller, and an energy source (such as a battery). Often, smart object networks are considered field area networks (FANs), neighborhood area networks (NANs), etc. Generally, size and cost constraints on smart object nodes (for example, sensors) result in corresponding constraints on resources, such as energy, memory, computational speed, and bandwidth.

Mesh networks have become increasingly popular and practical in recent years. In particular, shared-media mesh networks, such as wireless or PLC networks, etc., are often on what is referred to as Low Power and Lossy Networks (LLNs). LLNs are a class of network in which both the routers and their interconnects are constrained: LLN routers typically operate with constraints (for example, processing power, memory, and/or energy (battery)), and their interconnects are characterized by, illustratively, high loss rates, low data rates, and/or instability. LLNs are comprised of anything from a few dozen or up to thousands or even millions of LLN routers. Additionally, LLN's support point-to-point traffic (between devices inside the LLN), point-to-multipoint traffic (from a central control point, such as the root node, to a subset of devices inside the LLN), and multipoint-to-point traffic (from devices inside the LLN towards a central control point).

Loosely, the term “Internet of Things” or “IoT” may be used by those in the network field to refer to uniquely identifiable objects (things) and their virtual representations in a network-based architecture. In particular, the next frontier in the evolution of the Internet is the ability to connect more than just computers and communications devices, but also the ability to connect “objects” in general, such as lights, appliances, vehicles, HVAC (heating, ventilating, and air-conditioning), windows, window shades, and blinds, doors, locks, etc. The “Internet of Things” thus generally refers to the interconnection of objects (for example, smart objects), such as sensors and actuators, over a computer network (for example, interne protocol (“IP”)), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid, smart cities, building and industrial automation, and cars (for example, that can interconnect millions of objects for sensing things like power quality, tire pressure, and temperature, and that can actuate engines and lights), it has been of the utmost importance to extend the IP protocol suite for these networks.

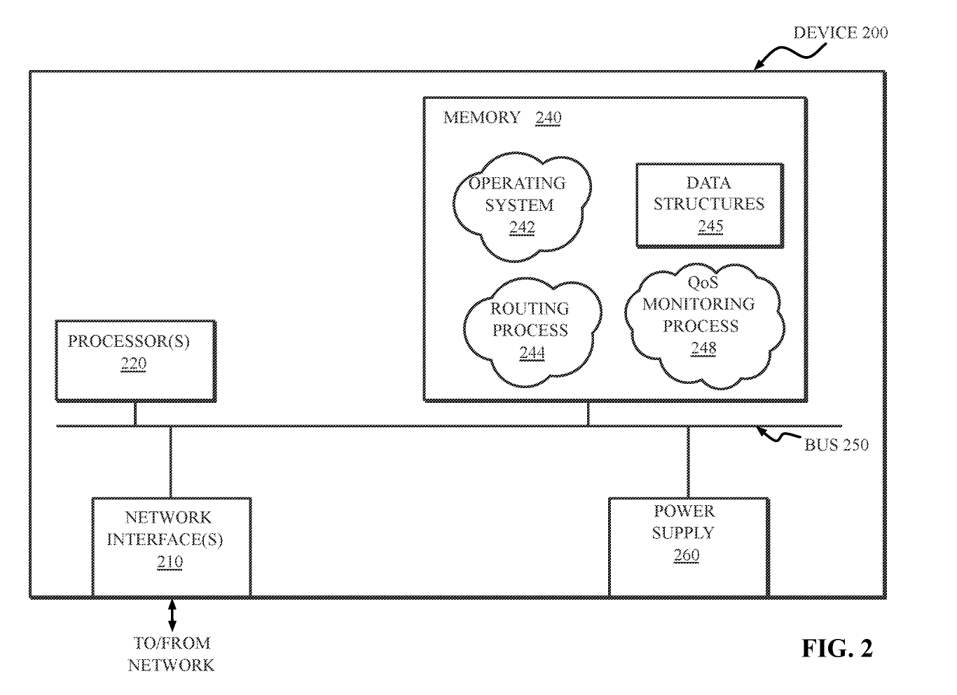

FIG. 1 is a schematic block diagram of an example computer network 100 illustratively comprising nodes/devices 200 (for example, labeled as shown, “root,” “11,” “12,” . . . “45,” and described in FIG. 2 below) interconnected by various methods of communication. For instance, the links 105 may be wired links or shared media (for example, wireless links, PLC links, etc.) where certain nodes 200 (such as, for example, routers, sensors, computers, etc.) may be in communication with other nodes 200, for example, based on distance, signal strength, current operational status, location, etc. Those skilled in the art will understand that any number of nodes, devices, links, etc. may be used in the computer network 100 and that the view illustrated herein is for simplicity. Also, those skilled in the art will further understand that while the network 100 is shown in a certain orientation, particularly with a “root” node, the network 100 is merely an example illustration that is not meant to limit the disclosure. In addition, a network management server (NMS) 130, or other head-end application device located beyond the root device (for example, via a WAN), may also be in communication with the network 100.

Data packets 140 (for example, traffic and/or messages sent between the devices/nodes) may be exchanged among the nodes/devices of the computer network 100 using predefined network communication protocols, such as certain known wired protocols, wireless protocols (for example, WiFi, Bluetooth®, etc.), PLC protocols, or other shared-media protocols where appropriate. In this context, a protocol comprises of a set of rules defining how the nodes interact with each other.

FIG. 2 is a schematic block diagram of an example node/device 200 that may be used with one or more embodiments described herein, for example, as any of the nodes shown in FIG. 1 above. The device 200 may comprise one or more network interfaces 210 (for example, wired, wireless, PLC, etc.), at least one processor 220, and a memory 240 interconnected by a system bus 250, as well as a power supply 260 (for example, battery, plug-in, etc.).

The network interface(s) 210 contain the mechanical, electrical, and signaling circuitry for communicating data over links 105 coupled to the network 100. The network interfaces may be configured to transmit and/or receive data using a variety of different communication protocols. Note, further, that the nodes 200 may have multiple types of network connections, for example, wireless and wired/physical connections, and that the view depicted herein is merely for illustration. Also, while the network interface 210 is shown separately from the power supply 260, the network interface 210 may communicate through the power supply 260 or may be an integral component of the power supply, for example, for PLC. In some specific configurations, the PLC signal may be coupled to the power line feeding into the power supply.

The memory 240 comprises a plurality of storage locations that are addressable by the processor 220 and the network interfaces 210 for storing software programs and data structures associated with the embodiments described herein. Note that certain devices may have limited memory or no memory (for example, no memory for storage other than for programs/processes operating on the device and associated caches). The processor 220 may comprise hardware elements or hardware logic adapted to execute the software programs and manipulate the data structures 245. An operating system 242, portions of which are typically resident in memory 240 and executed by the processor 220, functionally organizes the device by, inter alia, invoking operations in support of software processes and/or services executing on the device. These software processes and/or services may comprise routing process/services 244 and an illustrative “QoS monitoring” process 248, as described herein. Note that while QoS monitoring process 248 is shown in centralized memory 240, alternative embodiments provide for the process to be specifically operated within the network interfaces 210, such as a component of a network layer operation within the network interfaces 210 (as process “248a”).

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (for example, according to the functionality of a similar process). Further, while the processes have been shown separately, those skilled in the art will appreciate that processes may be routines or modules within other processes.

Routing process (services) 244 contains computer executable instructions executed by the processor 220 to perform functions provided by one or more routing protocols, such as proactive or reactive routing protocols, as will be understood by those skilled in the art. These functions may, on capable devices, be configured to manage a routing/forwarding table (a data structure 245) containing, for example, data used to make routing/forwarding decisions. In particular, in proactive routing, connectivity is discovered and known prior to computing routes to any destination in the network, for example, using link state routing such as Open Shortest Path First (OSPF), Intermediate-System-to-Intermediate-System (ISIS), or Optimized Link State Routing (OLSR). Reactive routing, on the other hand, discovers neighbors (in other words, it does not have an a priori knowledge of network topology) and, in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), Dynamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

Low power and Lossy Networks (LLNs), for example, certain sensor networks, may be used in a myriad of applications, such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, for example, considerably affecting bit error rate (BER);
2) Links are generally low bandwidth, such that control plane traffic must generally be bounded and negligible compared to the low rate data traffic;
3) A number of use cases require specifying a set of link and node metrics, some of them being dynamic, thus requiring specific smoothing functions to avoid routing instability, which considerably drains bandwidth and energy;
4) Constraint-routing may be required by some applications, for example, to establish routing paths that will avoid non-encrypted links, nodes running low on energy, etc.;
5) Scale of the networks may become very large, for example, on the order of several thousands to millions of nodes; and
6) Nodes may be constrained with low memory, a reduced processing capability, a low power supply (for example, battery), etc.

An example implementation of LLNs is an “Internet of Things” network. As described above, the term “Internet of Things” or “IoT” may be used by those in the art to refer to uniquely identifiable objects (things) and their virtual representations in a network-based architecture.

One example protocol is specified in Internet Engineering Task Force (IETF) Proposed Standard, Request for Comment (RFC) 6550, entitled “RPL: IPv6 Routing Protocol for Low Power and Lossy Networks” by Winter, et al. (March 2012). This protocol provides a mechanism that supports multipoint-to-point (MP2P) traffic from devices inside the LLN towards a central control point (for example, LLN Border Routers (LBRs) or “root nodes/devices” generally), as well as point-to-multipoint (P2MP) traffic from the central control point to the devices inside the LLN (and also point-to-point or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

A DAG is a directed graph having the property that all edges (and/or vertices) are oriented in such a way that no cycles (loops) are supposed to exist. All edges are contained in paths oriented toward and terminating at one or more root nodes (for example, “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, in other words, at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (for example, the farther away a node is from a root, the higher the rank of that node). Further, in certain embodiments, a sibling of a node within a DAG may be defined as any neighboring node that is located at the same rank within a DAG. Note that siblings do not necessarily share a common parent, and routes between siblings are generally not part of a DAG since there is no forward progress (their rank is the same). Note also that a tree is a kind of DAG, where each device/node in the DAG generally has one parent or one preferred parent.

DAGs may generally be built (for example, by a DAG process) based on an Objective Function (OF). The role of the objective function is generally to specify rules on how to build the DAG (for example, number of parents, backup parents, etc.).

In addition, one or more metrics/constraints may be advertised by the routing protocol to optimize the DAG against. Also, the routing protocol allows for including an optional set of constraints to compute a constrained path, such as if a link or a node does not satisfy a required constraint, it is “pruned” from the candidate list when computing the best path. Alternatively, the constraints and metrics may be separated from the objective function. Additionally, the routing protocol may include a “goal” that defines a host or set of hosts, such as a host serving as a data collection point, or a gateway providing connectivity to an external infrastructure, where a DAG's primary objective is to have the devices within the DAG be able to reach the goal. In the case where a node is unable to comply with an objective function or does not understand or support the advertised metric, it may be configured to join a DAG as a leaf node. As used herein, the various metrics, constraints, policies, etc. are considered “DAG parameters.”

Illustratively, example metrics used to select paths (for example, preferred parents) may comprise cost, delay, latency, bandwidth, expected transmission count (ETX), etc., while example constraints that may be placed on the route selection may comprise various reliability thresholds, restrictions on battery operation, multipath diversity, bandwidth requirements, transmission types (for example, wired, wireless, etc.), etc. The objective function may provide rules defining the load balancing requirements, such as a number of selected parents (for example, single parent trees or multi-parent DAGs). Notably, an example for how routing metrics and constraints may be obtained may be found in an IETF Internet Draft, entitled “Routing Metrics used for Path Calculation in Low Power and Lossy Networks” <draft-ietf-roll-routing-metrics-19> by Vasseur, et al. (Mar. 1, 2011 version). Further, an example objective function (for example, a default objective function) may be found in an IETF RFC, entitled “RPL Objective Function 0” <RFC 6552> by Thubert (March 2012 version) and “The Minimum Rank Objective Function with Hysteresis” <RFC 6719> by O. Gnawali et al. (September 2012 version).

Building a DAG may utilize a discovery mechanism to build a logical representation of the network and a route dissemination to establish state within the network so that routers know how to forward packets toward their ultimate destination. Note that a “router” refers to a device that can forward as well as generate traffic, while a “host” refers to a device that can generate but does not forward traffic. Also, a “leaf” may be used to generally describe a non-router that is connected to a DAG by one or more routers, but cannot itself forward traffic received on the DAG to another router on the DAG. Control messages may be transmitted among the devices within the network for discovery and route dissemination when building a DAG.

According to the illustrative RPL protocol, a DODAG Information Object (DIO) is a type of DAG discovery message that carries information that allows a node to discover a RPL Instance, learn its configuration parameters, select a DODAG parent set, and maintain the upward routing topology. In addition, a Destination Advertisement Object (DAO) is a type of DAG discovery reply message that conveys destination information upwards along the DODAG so that a DODAG root (and other intermediate nodes) can provision downward routes. A DAO message includes prefix information to identify destinations, a capability to record routes in support of source routing, and information to determine the freshness of a particular advertisement. Notably, “upward” or “up” paths are routes that lead in the direction from leaf nodes towards DAG roots, for example, following the orientation of the edges within the DAG. Conversely, “downward” or “down” paths are routes that lead in the direction from DAG roots towards leaf nodes, for example, generally going in the opposite direction to the upward messages within the DAG.

Generally, a DAG discovery request (for example, DIO) message is transmitted from the root device(s) of the DAG downward toward the leaves, informing each successive receiving device how to reach the root device (that is, from where the request is received is generally the direction of the root). Accordingly, a DAG is created in the upward direction toward the root device. The DAG discovery reply (for example, DAO) may then be returned from the leaves to the root device(s) (unless unnecessary, such as for UP flows only), informing each successive receiving device in the other direction how to reach the leaves for downward routes. Nodes that are capable of maintaining routing state may aggregate routes from DAO messages that they receive before transmitting a DAO message. Nodes that are not capable of maintaining routing state, however, may attach a next-hop parent address. The DAO message is then sent directly to the DODAG root that can in turn build the topology and locally compute downward routes to all nodes in the DODAG. Such nodes are then reachable using source routing techniques over regions of the DAG that are incapable of storing downward routing state. In addition, RPL also specifies a message called the DIS (DODAG Information Solicitation) message that is sent under specific circumstances so as to discover DAG neighbors and join a DAG or restore connectivity.

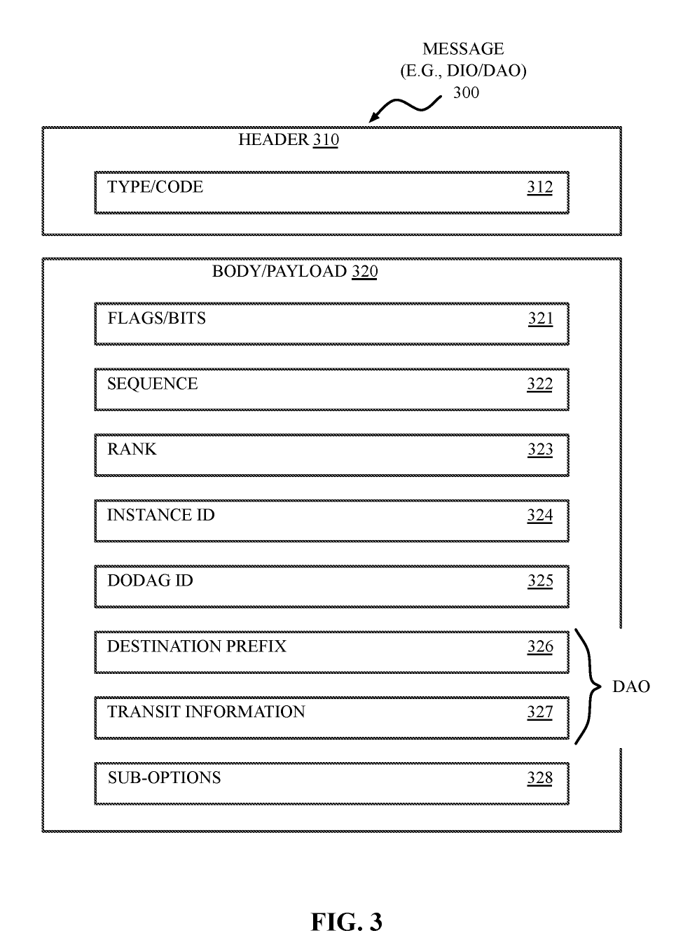

FIG. 3 illustrates an example simplified control message format 300 that may be used for discovery and route dissemination when building a DAG, for example, as a DIO, DAO, or DIS message. Message 300 illustratively comprises a header 310 with one or more fields 312 that identify the type of message (for example, a RPL control message) and a specific code indicating the specific type of message, for example, a DIO, DAO, or DIS. Within the body/payload 320 of the message may be a plurality of fields used to relay pertinent information. In particular, the fields may comprise various flags/bits 321, a sequence number 322, a rank value 323, an instance ID 324, a DODAG ID 325, and other fields, each as may be appreciated in more detail by those skilled in the art. Further, for DAO messages, additional fields for destination prefixes 326 and a transit information field 327 may also be included, among others (for example, DAO_Sequence used for acknowledgements (ACKs), etc.). For any type of message 300, one or more additional sub-option fields 328 may be used to supply additional or custom information within the message 300. For instance, an objective code point (OCP) sub-option field may be used within a DIO to carry codes specifying a particular objective function to be used for building the associated DAG. Alternatively, sub-option fields 328 may be used to carry other information within a message 300, such as indications, requests, capabilities, lists, notifications, etc., for example, in one or more type-length-value (TLV) fields.

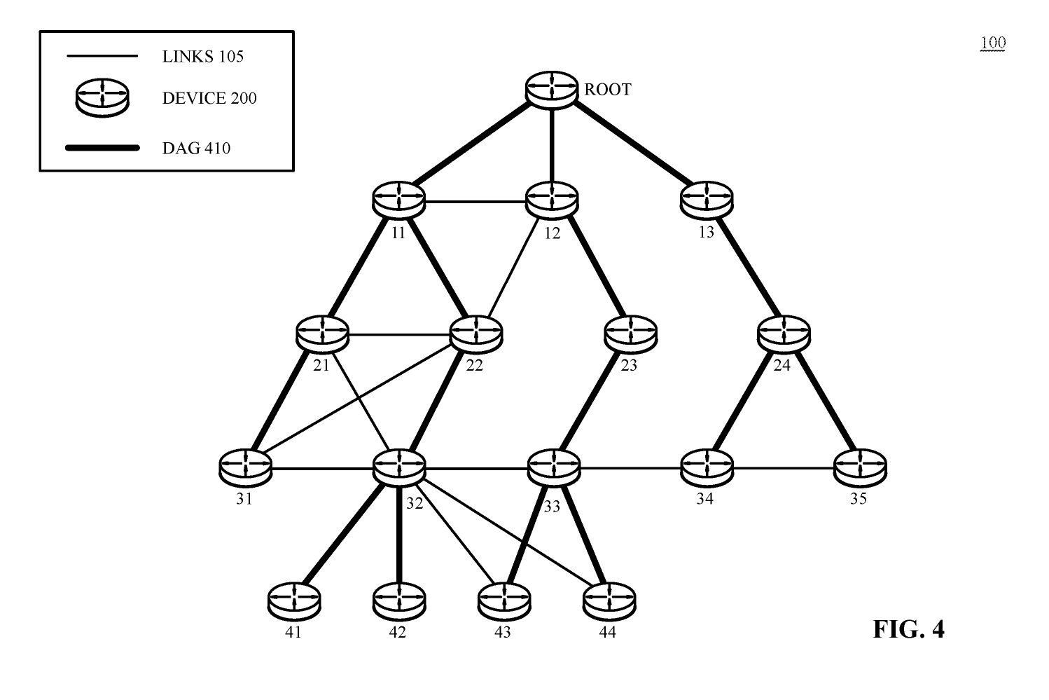

FIG. 4 illustrates an example simplified DAG that may be created, for example, through the techniques described above, within the network 100 of FIG. 1. For instance, certain links 105 may be selected for each node to communicate with a particular parent (and thus, in the reverse, to communicate with a child, if one exists). These selected links form the DAG 410 (shown as bolded lines), which extends from the root node toward one or more leaf nodes (nodes without children). Traffic/packets 140 (shown in FIG. 1) may then traverse the DAG 410 in either the upward direction toward the root or downward toward the leaf nodes, particularly as described herein. Note that although certain examples described herein relate to DAGs, the embodiments of the disclosure are not so limited and may be based on any suitable routing topology, particularly for constrained networks.

As noted above, shared-media communication networks, such as wireless and power-line communication (PLC) networks (a type of communication over power-lines), provide an enabling technology for networking communication and can be used for example in Advanced Metering Infrastructure (AMI) networks, and are also useful within homes and buildings. Interestingly, PLC lines share many characteristics with low power radio (wireless) technologies. In particular, though each device in a given PLC network may be connected to the same physical power-line, due to their noisy environment, a PLC link provides limited range and connectivity is highly unpredictable, thus requiring multi-hop routing when the signal is too weak. For instance, the far-reaching physical media exhibits a harsh noisy environment due to electrical distribution transformers, commercial and residential electric appliances, and cross-talk effects. As an example, even within a building, the average number of hops may be between two and three (even larger when having cross phases), while on an AMI network on the same power phase line the number of hops may vary during a day between one and 15-20. Those skilled in the art would thus recognize that due to various reasons, including long power lines, interferences, etc., a PLC connection may traverse multiple hops. In other words, PLC cannot be seen as a “flat wire” equivalent to broadcast media (such as Ethernet), since they are multi-hop networks by essence.

Furthermore, such communication links are usually shared (for example, by using wireless mesh or PLC networks) and provide a very limited capacity (for example, from a few Kbits/s to a few dozen Kbits/s). LLN link technologies typically communicate over a physical medium that is strongly affected by environmental conditions that change over time. For example, LLN link technologies may include temporal changes in interference (for example, other wireless networks or electric appliances), spatial/physical obstruction (for example, doors opening/closing or seasonal changes in foliage density of trees), and/or propagation characteristics of the physical media (for example, changes in temperature, humidity, etc.). The timescale of such temporal changes may range from milliseconds (for example, transmissions from other wireless networks) to months (for example, seasonal changes of outdoor environment). For example, with a PLC link the far-reaching physical media typically exhibits a harsh noisy environment due to a variety of sources including, for example, electrical distribution transformers, commercial and residential electric appliances, and cross-talk effects. Real world testing suggests that PLC link technologies may be subject to high instability. For example, testing suggests that the number of hops required to reach a destination may vary between 1 and 17 hops during the course of a day, with almost no predictability. It has been observed that RF and PLC links are prone to a number of failures, and it is not unusual to see extremely high Bit Error Rates (BER) with packet loss that may be as high as 50-60%, coupled with intermittent connectivity.

As further noted above, many LLNs, particularly AMI networks, demand that many different applications operate over the network. For example, the following list of applications may operate simultaneously over AMI networks:
1) Automated Meter Reading that involves periodically retrieving meter readings from each individual meter to a head-end server;
2) Firmware upgrades, for example, that involve communicating relatively large firmware images (often 500 KB or more) from a head-end server to one device, multiple devices, or all devices in the network;
3) Retrieving load curves;
4) Real-time alarms generated by meters (for example, power outage events) that actually act as sensors;
5) Periodically retrieving network management information from each meter to a Network Management System (NMS) 130;
6) Supporting demand response applications by sending multicast messages from a head-end device to large numbers of meters;
7) Etc.
   One of skill in the art will appreciate that the above-enumerated examples are similar for other types of LLNs.

Generally speaking, these different applications have significantly different traffic characteristics, for example, unicast vs. multicast, small units of data vs. large units of data, low-latency vs. latency-tolerant, flows toward a head-end vs. away from the head-end, etc. Furthermore, since these applications must operate simultaneously over a highly constrained LLN network, the network can easily experience congestion, especially when different applications are sending traffic simultaneously. For example, the bandwidth of LLN links may be as low as a few Kbits/s, and even lower when crossing transformers (for PLC). Without proper mechanisms, these situations can cause networks to violate critical service layer agreements (SLAs), for example, delaying the reception of critical alarms from a meter. Accordingly, Quality of Service (QoS) mechanisms are a critical functionality in shared-media communication networks, particularly in highly constrained LLNs.

Numerous QoS mechanisms have been developed for “classic” IP networks (unconstrained), including: (1) packet coloring and classification (for example, by applications or Edge network entry points), (2) congestion avoidance algorithms with random drops for back-pressure on Transmission Control Protocol (TCP) (for example, WRED, etc.), (3) queuing techniques (for example, preemptive queuing+round robin+dynamic priorities), (4) bandwidth reservation (for example, Diffserv (by CoS), Intserv (RSVP(-TE), etc.), (5) Input/Output shaping (for example, congestion-based traffic shaping), (6) Call Admission Control (CAC) using protocols such as the Resource reSerVation Protocol (RSVP) and/or input traffic shapers, (7) Traffic Engineering, and (8) Congestion Avoidance techniques, etc. However, while some of these techniques may apply to LLNs, most are not suitable because they are too costly in terms of bandwidth (control plane overhead), memory (state maintenance), and/or CPU processing. Indeed, policies must be specified for packet coloring, and queuing techniques and congestion avoidance algorithms, such as WRED, must be configured on nodes. Such algorithms require a deep knowledge of traffic patterns, link layer characteristics, and node resources with respect to a number of parameters to configure each individual device.

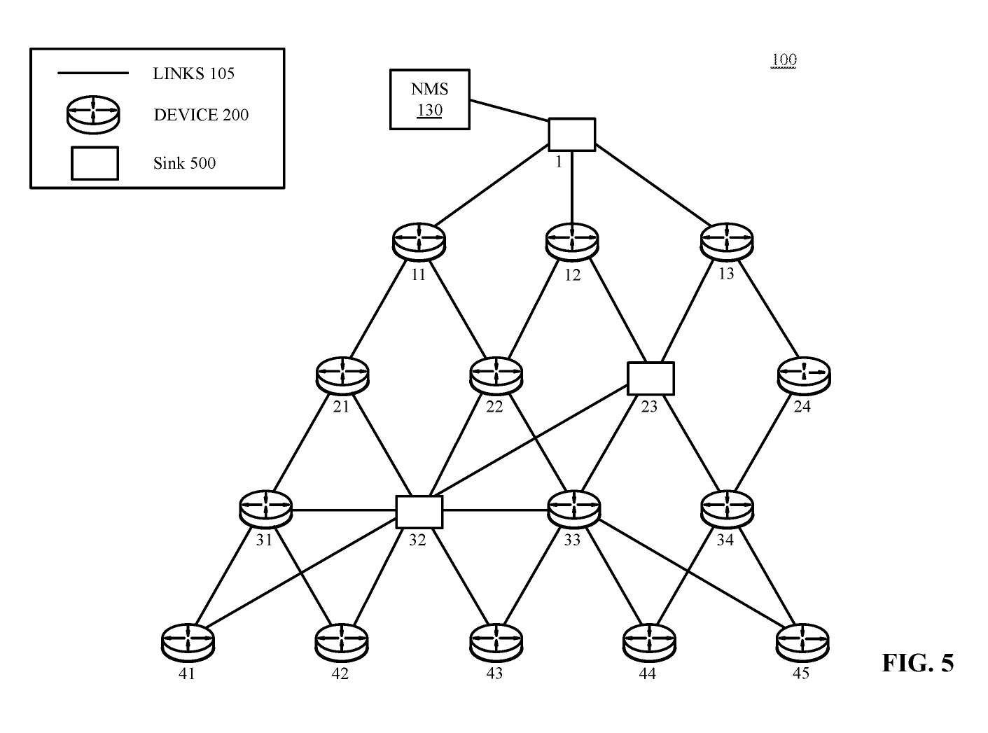

Although the techniques described herein are illustrated with respect to an LLN in which network traffic transits through the root/LBR, it should be noted that the techniques described herein may be generally applied to any network, particularly to any constrained network. For example, as shown in FIG. 5, a network 100 that does not have a central node through which all traffic is piped (for example, like the LBR of an LLN), may have one or more sinks 500 that reside at strategic locations throughout the network (for example, nodes 1, 23, and 32) to ensure that all potential traffic within the network may be monitored and routed according to the techniques described herein. In such an environment, the sinks may operate independently or in collaboration (for example, with each other or with an NMS) to perform the techniques described herein.

The techniques described herein may be performed by hardware, software, and/or firmware, such as in accordance with the “QoS monitoring” process 248/248a shown in FIG. 2, which may contain computer executable instructions executed by the processor 220 (or independent processor of interfaces 210) to perform functions relating to the techniques described herein, for example, in conjunction with routing process 244. For example, the techniques herein may be treated as extensions to conventional protocols, such as the various PLC protocols or wireless communication protocols, and as such, may be processed by similar components understood in the art that execute those protocols.

### Upgrading Network Firmware

The disclosed embodiments propose a novel method for a Network Management System (“NMS”) to develop a centralized scheduling and distributed dissemination of firmware blocks that will save processing capacity and reduce the bandwidth required for the communications. After the initial communication of the blocks to the nodes, the NMS receives a bitmap from the nodes indicating which of the blocks each node is missing from the update. The NMS analyzes a known topology map of the network to identify particular nodes that are missing blocks and source nodes that have the blocks and are nearest to the particular recipient nodes.

The NMS determines the route for the source node with the block to deliver the block to the recipient node that this missing a block. The NMS communicates commands to the network that includes the instructions to deliver the missing blocks. Source nodes that are identified and instructed to communicate a block to a recipient node proceed to communicate the blocks. The recipient nodes missing blocks receive the communicated blocks.

In network systems, one of the key customer requirements is to update the nodes' firmware in the field deployment. In a typical smart unity network application, there can be thousands of nodes connect to a Field Area Router (“FAR”). If the upgrade cycle happens, thousands of nodes need to receive the image firmware simultaneously. The entire upgrade process for a conventional network may take days or weeks. One challenge is to accelerate the upgrading process and reduce the bandwidth occupation for the upgrade. In a conventional upgrade, the firmware file is split into blocks by the NMS. In an example default firmware split, each block is approximately 650 bytes. The NMS will send each block to all nodes in the firmware group either using multicast or unicast. When all the blocks are sent to all nodes, the first round of communications are complete.

In the conventional network example, NMS will try five rounds for the firmware download. The number of rounds is configurable by the NMS. In the first round, the NMS sends all blocks. In the second through fifth rounds, the NMS attempts to send blocks to nodes that did not receive all of the blocks. After each round, the NMS requests the bitmap of image information from each node via CoAP protocol. The bitmap value shows the image blocks status, which indicates blocks that are missing from each node. The NMS sends the lost image blocks to each for the node filling the firmware holes based on the received bitmap information. In a conventional system, the NMS requires five a configurable number of communications or more to resend all of the image blocks. In an example, the configurable number communications is five. In this example, all the image blocks are originated from the NMS and traverse the whole path to the destination nodes five times. This method wastes system bandwidth since all the intermediate nodes need to forward the image blocks towards the intended recipient. Moreover, a long path transmission increases the packet loss possibilities. In a typical deployment, the upgrade may take days or weeks to upgrade thousands of nodes. In the conventional example, if, after five communications, a node fails to be completely upgraded, the node requires manual upgrading.

By using and relying on the methods and systems described herein, after the first round, the NMS gathers bitmap information of missing blocks of all the nodes. The NMS then determines a scheduling strategy for distributing missing blocks to the corresponding nodes. Instead of sending all image blocks directly from the NMS, the NMS sends commands to the involved nodes and starts transmission from those nodes. The command contains information of missing image blocks and the nearest path from the source to destination. In this way, the missing blocks only need to traverse a short path. By combining centralized scheduling and distributed dissemination, the method can greatly reduce the overall traffic cost and accelerate the whole process with better QoS.

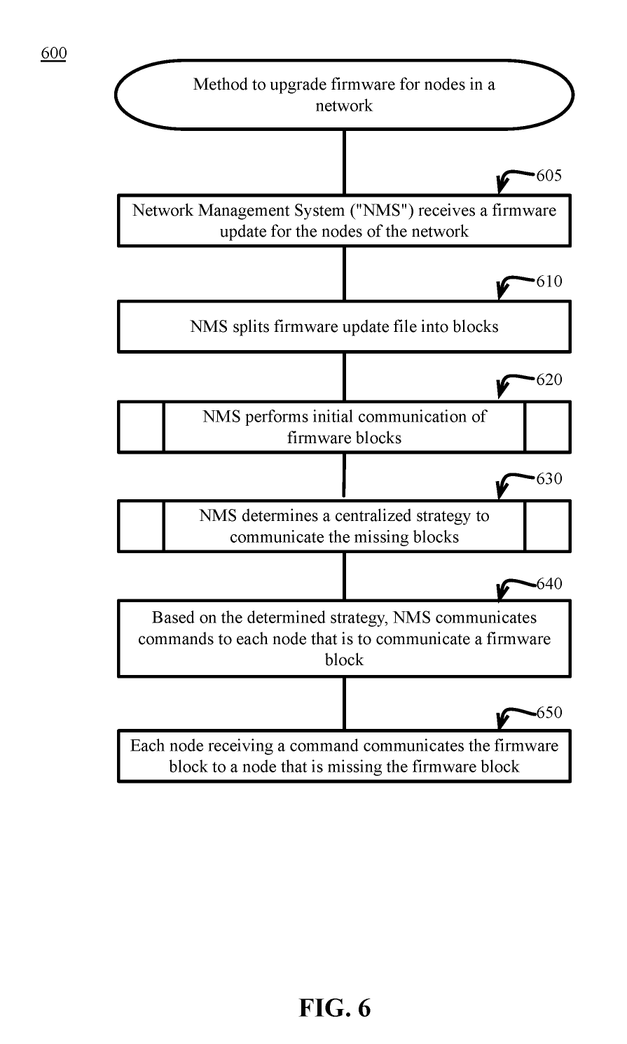

FIG. 6 is a block flow diagram depicting a method 600 to upgrade firmware for nodes 200n in a network, in accordance with certain example embodiments. The method 600 is described with reference to the components illustrated in FIGS. 1-5.

In block 605, a NMS 130 associated with a network of a plurality of nodes 200n receives a firmware update for the nodes 200 of the network. In the examples, one or more of the nodes 200 may be referred to collectively as nodes 200n to represent any combination of multiple nodes 200 or the entirety of the nodes 200. A specific example node may be represented as node 200a, 200b, or 200c. For example, a node 200a may be is a recipient node 200a in need of a firmware update block. In the example, a second node 200b may be a source node 200b that is requested to communicate the firmware update block.

The update may be provided by a network management operator. The update may be received from a manufacturer of the NMS 130, the nodes 200n or any other suitable manufacturer. The update may be provided by a software management provider associated with the network system. Any suitable provider may supply the firmware update. The firmware update may be a software update for the nodes 200n, a configuration update of the software of the nodes 200n, or any other update to the firmware of the nodes 200n.

In block 610, the NMS 130 splits the firmware update file into blocks. The firmware update may be divided into blocks for communication to the nodes 200n. For example, the firmware update may be divided based on a logical division of the software code of the firmware update. For example, each block may be associated with a particular function of the nodes 200n. The firmware update may be divided into blocks for easier communication, such as to allow each block to be communicated in individual packets instead of a as part of a much larger communication packet.

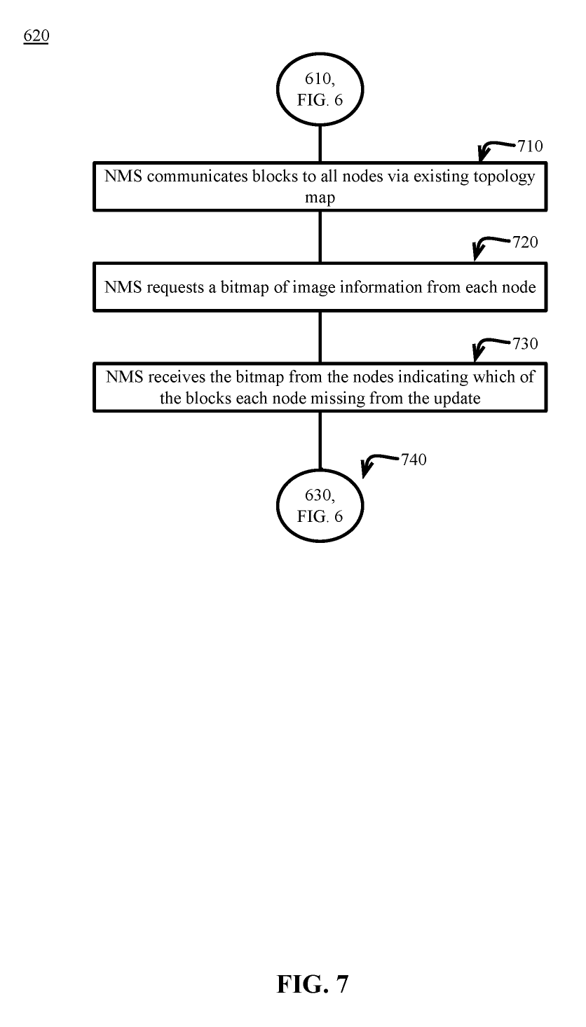

In block 620, the NMS 130 performs an initial communication of the firmware blocks. The details of block 620 are discussed in greater detail in the method 620 of FIG. 7.

FIG. 7 is a block flow diagram depicting a method 620 to perform an initial communication of the firmware blocks, in accordance with certain examples. The method 620 is described with reference to the components illustrated in FIGS. 1-5.

In block 710, the NMS 130 communicates the firmware blocks to nodes 200n via an existing topology map. The NMS 130 prepares the data packets with the blocks for communication to each required node, such as node 200a and node 200b, of the nodes 200n. In certain examples, all of the nodes 200n receive the communication. In certain examples, only specific nodes, 200a, 200b, receive the communication. The NMS 130 may use an existing understanding of the topography of the network, such as a network topography map, to determine the specifics of the communication. For example, the NMS 130 may include instructions in the communication specifying a route or path for the communication to travel from the NMS 130 to one or more destination nodes 200n. The specifies of the communication, such as an overall strategy of which nodes 200n are to receive the firmware update, may be provided to the NMS 130 by a network operator, provided as part of the data of the firmware update by a software management provider associated with the network system, or provided by any suitable system or operator. For example, the overall strategy may specify that only certain nodes 200n receive the firmware update, or that some nodes 200n only receive certain ones of the blocks.

In block 720, the NMS 130 requests a bitmap of image information from each node 200n. The NMS 130 communicates a request to each desired node 200n, such as node 200a and node 200b, to provide a status of the blocks that each node 200n has received. The communication may be transmitted to each node 200n or only to nodes 200n that have received the firmware blocks. The communication may be included as a data packet in the communication of the firmware blocks or may be a separate communication.

In block 730, the NMS 130 receives the bitmap from the nodes 200n indicating which of the blocks each node 200n is missing from the update. For example, a node 200a determines which of the blocks has been received for the firmware upgrade and which blocks may be missing. The node 200a may determine which blocks are missing based on a comparison of the received blocks to a list of expected blocks provided by the NMS 130. The node 200a may determine which blocks are missing based on a comparison of the received blocks to a known number of blocks required for a complete firmware upgrade. Any other method of determining which blocks are missing may be used.

The node 200a communicates a status of the blocks received to the NMS 130 in any suitable manner. For example, the node 200a may prepare a data packet of the blocks received, the blocks missing, an overall block status, or any other configuration of message and communicate the data packet to the NMS 130. The node 200a may combine the block status with the block status of other nodes 200n and communicate the combined block status to the NMS 130. The NMS 130 receives the communications either individually from each node 200a or collectively from all of the nodes 200n.

From block 730, the method 620 proceeds to block 630 in FIG. 6.

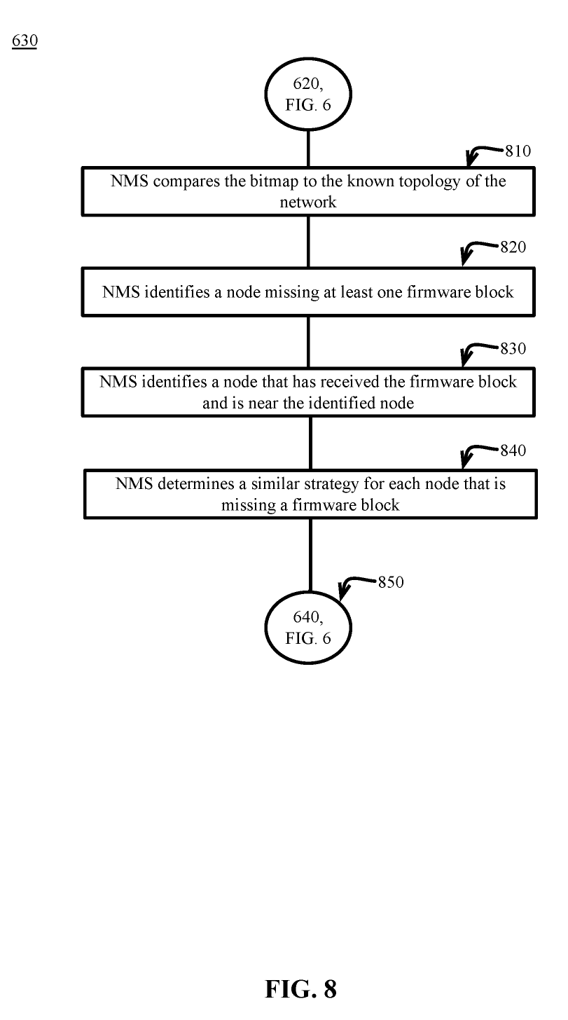

Returning to FIG. 6, in block 630, the NMS 130 determines a centralized strategy to communicate the missing blocks. The details of block 630 are discussed in greater detail in the method 630 of FIG. 8.

FIG. 8 is a block flow diagram depicting a method 630 to determine a centralized strategy to communicate the missing blocks, in accordance with certain examples.

In block 810, the NMS 130 compares the bitmap to the known topology of the network. The NMS 130 may compare each node 200n or other component of the network in the known topology of the network to the received communications to determine if each node 200n, such as node 200a and 200b, has provided a status of the received blocks. The NMS 130 then compares the status of each node 200n, such as node 200a and 200b, to the overall strategy for the firmware update as described in block 710. For example, if the overall strategy for the firmware update specified that node 200a should receive all of the firmware blocks, then the NMS 130 may analyze the communication from node 200a to determine if all the firmware blocks were successfully received by the node 200a.

In block 820, the NMS 130 identifies a node 200a missing at least one firmware block. In the comparison of the received communication from node 200a to the overall strategy for the firmware update, the NMS 130 determines that node 200a did not receive all of the blocks that are required for that node 200a to be successfully upgraded. In an example, other nodes 200n may also be missing at least one firmware block.

In block 830, the NMS 130 identifies a node 200b that has received the firmware block and is near the identified node 200a. In an example, the node 200a is missing a particular block. Node 200b is near the node 200a, and node 200b did receive the particular block. The NMS 130 may determine that node 200b has the particular node based on the receipt of the communication from node 200b. The NMS 130 determines that node 200b is near node 200a based on the known topology map of the network. For example, the topology map may show the interconnections between the nodes 200a and 200b. For example, node 200a may be adjoining node 200b, that is nodes 200a and 200b may communicate directly with each other without any intervening hops.

In another example, nodes 200a and 200b may not be adjoining each other, but node 200b is the closest node to 200a that has the block that node 200a is missing. In the example, one or more other nodes, such as 200c may be in between nodes 200a and 200b, but node 200c does not have the particular block that node 200a needs. In this case, node 200b might be required to communicate the particular block to node 200c and request that node 200c communicate the particular block to node 200a. Any distance or number of hops between a node 200b that has the block and the node 200a that needs the block may be envisioned. The NMS 130 may seek a route that has the fewest number of hops from node 200b to node 200a.

The NMS 130 will desire to have a distance between node 200b to node 200a that is shorter than the distance between node 200a and the NMS 130. The shorter pathway between the two nodes 200a and 200b saves communication bandwidth and processing capacity. Further, the node 200b is only requested to communicate the needed blocks to node 200a and not the entire firmware update. This limited communication conserves communication bandwidth and processing capacity. If the NMS 130 were to communicate all of the blocks in this communication, as in conventional systems, more communication bandwidth would be required and processing capacity would be needed to perform the communication.

In block 840, the NMS 130 determines a similar strategy for each node 200n that is missing a firmware block. While determining the overall strategy for the communication, the NMS 130 performs an analysis similar to block 830 for each node 200n, such as node 200b and node 200c, that are missing at least one firmware block. Based on the interconnections of the topology map, the nodes 200n that possess needed blocks, the paths and routes from nodes 200n that have the firmware blocks and their positions relative to nodes 200n, such as 200b and 200c, that need a firmware block, the NMS 130 determines an overall strategy for instructing nodes 200n with firmware blocks to communicate the firmware blocks to nodes 200n that need the firmware blocks.

From block 840, the method 630 returns to block 640 of FIG. 6.

In block 640, based on the determined strategy, the NMS 130 communicates commands to each node 200n, such as node 200b, that is to communicate a firmware block. After determining the overall strategy for the communication, the NMS 130 transmits the communication to the network. The communication follows the topology map of the network to allow transmission to the desired nodes 200n.

In block 650, each node 200n receiving a command communicates the firmware block to a node 200n that is missing the firmware block. For example, if source node 200b has the firmware block and the NMS 130 instructs the source node 200b to communicate the firmware block to recipient node 200a, then the source node 200b prepares a communication packet comprising the firmware block and transmits the packet to recipient node 200a.

In an example, the source node 200b knows the path to the recipient node 200a. In this example, the source node 200b has stored the topology map or other instructions that allow the source node 200b to communicate to recipient node 200a. For example, when the NMS 130 communicates instructions to send a particular block to node 200a, node 200b accesses the topology map and determines the preferred route to send a communication to node 200a. The node 200b prepares the communication and transmits the communications along the determined route.

In an example, the source node 200b does not know the path to the recipient node 200a. In this example, the source node 200b relies on the stored topology map at the NMS 130 to provide instructions that allow the source node 200b to communicate to recipient node 200a. For example, the NMS 130 accesses the topology map and determines the preferred route to send a communication from node 200b to node 200a. When the NMS 130 communicates instructions to send a particular block to node 200a, the NMS 130 also communicates the preferred route to send a communication to node 200a. The node 200b prepares the communication and transmits the communications along the communicated route.

When the recipient node 200a receives the particular block, the particular block is stored along with other received firmware blocks. The blocks may be used collectively to update the firmware of the node 200a, along with all the other nodes 200n, upon receiving instructions from the NMS 130 or at any other configured time.

In an example, the node 200a provides another update to the NMS 130 to confirm that all the firmware blocks have been received. After all nodes 200n have received all the required blocks, the NMS 130 may provide instructions to proceed with installing the firmware update.

In an example, if the node 200a is still missing a block, the node 200a may provide notice to the NMS 130 that a block is still missing as described in blocks 720 to block 730. The method 600 may be repeated as often as necessary to ensure that every node 200n requiring firmware blocks has received the required firmware blocks.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, an ordinarily skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be repeated, performed in a different order, in parallel with one another, omitted entirely, and/or combined between different example embodiments, and/or certain additional acts can be performed, without departing from the scope and spirit of various embodiments. Accordingly, such alternative embodiments are included in the invention claimed herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structure.

1. A method, comprising:
by a network management system;
in a low power and lossy network (LLN) comprising one or more interfaces and a plurality of nodes, communicating a plurality of blocks of data to a plurality of nodes, wherein the plurality of nodes are separate and distinct from the network management system;
receiving a status of each of the plurality of nodes, the status indicating which of the blocks of data have been received by each of the plurality of nodes;
determining based on the received statuses that a first node has not received a particular block of data;
determining based on the received statuses one or more nodes that have received the particular block of data;
determining an overall strategy to communicate the particular block of data to the first node from the one or more nodes that have received the particular block of data, wherein the strategy comprises selecting a second node from the one or more nodes that have received the particular block of data, the second node being located along a shortest pathway from the first node as compared to a pathway length between the first node and each of the remaining nodes of the one or more nodes that have received the particular block of data; and
communicating instructions to the second node to communicate the particular block of data to the first node, wherein the instructions are comprised of a route for the second node to communicate the particular block of data to the first node, and wherein the route is comprised of the shortest pathway from the first node to the second node.

2. (canceled)

3. (canceled)

4. The method of claim 3, wherein the route is based on a topology of the LLN accessed by the network management system.

5. The method of claim 1, wherein the second node determines a route for the second node to communicate the particular block of data to the first node.

6. The method of claim 1, wherein the blocks of data comprise a firmware upgrade for the plurality of nodes.

7. The method of claim 1, wherein the pathway lengths between the first node and each of the one or more nodes receiving the particular block of data are based on a topology of the LLN accessed by the network management system.

8. The method of claim 1, further comprising receiving an updated status of each of the plurality of nodes, each of the updated statuses indicating that each of the blocks of data has been received by each of the plurality of nodes, and where each of the updated statuses is communicated subsequent to the status indicating which of the blocks of data have been received by each of the plurality of nodes.

9. A method, comprising:
in a low power and lossy network (LLN) comprising one or more interfaces and a plurality of nodes, communicating, by a network management system, one or more blocks of data to the plurality of nodes, wherein the plurality of nodes are separate and distinct from the network management system;
receiving, by a first node from a network management system, the one or more blocks of data comprising a particular block of data;
receiving, by a second node from the network management system, the one or more blocks of data except for the particular block of data;
receiving, by the first node and the second node from the network management system, a request for a status of the one or more blocks of data received;
communicating, by the first node to the network management system, a status of the blocks of data received;
communicating, by the second node to the network management system, a status of the blocks of data received;
determining, by the network management system based on the communicated statuses, that the second node did not receive the particular block of data;
determining, by the network management system, that the first node is located along a shortest pathway from the second node as compared to a pathway length between the second node and the plurality of nodes that have received the particular block of data;
receiving, by the first node, instructions from the network management system to communicate the particular block of data to the second node, wherein the instructions are comprised of a path for the first node to communicate the particular block of data to the second node, and wherein the path is comprised of the shortest pathway from the first node to the second node; and
communicating, by the first node, the particular block of data to the second node.

10. The method of claim 9, further comprising by the first node:
utilizing the path to communicate the particular block of data to the second node.

11. The method of claim 9, further comprising by the first node:
determining, based on a topology map accessed by the first node, a path to communicate the particular block of data to the second node; and
utilizing the path to communicate the particular block of data to the second node.

12. A computer program product, comprising a tangible, non-transitory, computer-readable media having software encoded thereon, the software when executed by a processor operable to:
communicate a plurality of blocks of data to a plurality of nodes;
receive a status of each of the plurality of nodes, the status indicating which of the blocks of data received by each of the plurality of nodes;
determine, based on the received statuses, that a first node has not received a particular block of data;
determine, based on the received statuses, one or more nodes that have received the particular block of data;
determine an overall strategy to communicate the particular block of data to the first node from the one or more nodes that have received the particular block of data, wherein the strategy comprises selecting a second node from the one or more nodes that have received the particular block of data, the second node being located along a shortest pathway from the first node as compared to a pathway length between the first node and each of the remaining nodes of the one or more nodes that have received the particular block of data; and
communicate instructions to the second node to communicate the particular block of data to the first node, wherein the instructions are comprised of a route for the second node to communicate the particular block of data to the first node, and wherein the route is comprised of the shortest pathway from the first node to the second node.

13. (canceled)

14. (canceled)

15. The computer program product of claim 12, wherein the second node determines a route for the second node to communicate the particular block of data to the first node.

16. The computer program product of claim 12, wherein the blocks of data comprise a firmware upgrade for the plurality of nodes.

17. A system, comprising:
a processor adapted to execute one or more processes; and
a memory configured to store a process executable by the processor, the process when executed operable to:
receive a status of each of a plurality of nodes, the status indicating which of a communication of blocks of data were received by each of the plurality of nodes;
determine, based on the received statuses, that a first node has not received a particular block of data;
determine, based on the received statuses, one or more nodes that have received the particular block of data;
determine an overall strategy to communicate the particular block of data to the first node from the one or more nodes that have received the particular block of data, wherein the strategy comprises selecting a second node from the one or more nodes that have received the particular block of data, the second node being located along a shortest pathway from the first node as compared to a pathway length between the first node and each of the remaining nodes of the one or more nodes that have received the particular block of data; and
communicate instructions to the second node to communicate the particular block of data to the first node, wherein the instructions are comprised of a route for the second node to communicate the particular block of data to the first node, and wherein the route is comprised of the shortest pathway from the first node to the second node.

18. The system of claim 17, wherein the blocks of data comprise a firmware upgrade for the plurality of nodes.

19. The system of claim 17, wherein the pathway lengths between the first node and each of the one or more nodes receiving the particular block of data are based on a topology of a low power and lossy network accessed by the network management system.

20. The system of claim 17, the process when executed being further operable to:
receive an updated status of each of the plurality of nodes, each of the updated statuses indicating that each of the blocks of data has been received by each of the plurality of nodes, and where each of the updated statuses is communicated subsequent to the status indicating which of the blocks of data have been received by each of the plurality of nodes.
